(19) United States
(12) Patent Application Publication
(10) Pub. No.: US 2006/0063108 A1
(43) Pub. Date: Mar. 23, 2006

(54) Multi-stack optical data storage medium and use of such medium

(75) Inventors: Mark Van Schijndel, Eindhoven (NL); Hubert Cecile Francois Martens, Eindhoven (NL); Benno Tieke, Eindhoven (NL); Guofu Zhou, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/533,713

(22) PCT Filed: Oct. 22, 2003
(86) PCT No.: PCT/IB03/04682

§ 371 Date: May 3, 2005

(30) Foreign Application Priority Data
Nov. 6, 2002 (EP) 02079629.8
Dec. 30, 2002 (EP) 02080572.7

(51) Int. Cl. G11B 7/24; G11B 15/64

(52) U.S. Cl. 430/270.14; 369/300

(57) ABSTRACT

The present invention relates to a multi-stack optical data storage medium (10). The medium comprises a first substrate (1a) with present on a side thereof a first recording stack (13) named L₀, a second substrate (1b) with present on a side thereof a second recording stack (12) named L₁ comprising a recordable type L₁ recording layer (4) having a thickness t_{RL1} and a complex refractive index n_{λ}−i*k_{λ} at a wavelength λ. A second reflective layer (6) is present adjacent the L₁ recording layer (4) at a side most remote from a radiation beam (20) entrance face (11) of the medium. The second recording stack L₁ (12) is present at a position closer to the entrance face (11) than the L₀ recording stack (13). A radiation beam transparent spacer layer (9) is sandwiched between the recording stacks (12, 13). In order to achieve compatibility with the DVD-9 ROM standard as far as reflection levels are concerned, the second reflective layer (6) mainly comprises the metal Cu and has a thickness t_{MLn} selected from the range of 8-20 nm and the thickness t_{RL1} and k_{λ} of the recordable L₁ recording layer (4) fulfils the formula t_{RL1}*k_{λ}≦8 nm.

The invention relates to a multi-stack optical data storage medium for recording using a focused radiation beam having a wavelength λ and entering through an entrance face of the medium during recording, comprising at least:
a first substrate with present on a side thereof:
a first recording stack named L₀, comprising a recordable type L₀ recording layer, and a first reflective layer present between the L₀ recording layer and the first substrate,
a second substrate with present on a side thereof:
a second recording stack named L₁ comprising a recordable type L₁ recording layer having a thickness t_{RL1} and a complex refractive index n_{λ}−i*k_{λ} at the wavelength λ, a second reflective layer present adjacent the L₁ recording layer at a side most remote from the entrance face, and said second recording stack L₁ being present at a position closer to the entrance face than the L₀ recording stack,
a spacer layer, transparent for the radiation beam, sandwiched between the recording stacks, said transparent spacer layer having a thickness substantially larger than the depth of focus of the focused radiation beam.

The invention also relates to the use of such a medium.

An embodiment of an optical recording medium as described in the opening paragraph is known from European Patent Application EP1067535A2. The most common embodiment of the medium is a circular disk.

Regarding the market for optical recording, it is clear that the most important and successful format so far is a write-once format, Compact Disk Recordable (CD-R). Although the take-over in importance by Compact Disk ReWritable (CD-RW) has been predicted since a long time, the actual market size of CD-R media is still at least an order of magnitude larger than for CD-RW. Furthermore the most important parameter for drives is the maximum write speed for R-media, not for RW. Of course, a possible shift of the market to CD-RW is still possible, e.g. because of Mount Rainier standardization for CD-RW. However, the R-format has been proven very attractive due to its 100% compatibility.

Recently the Digital Versatile Disk (DVD) has gained marketshare as a medium with a much higher data storage capacity than the CD. Presently, this format is available in a read only (ROM) and a rewritable (RW) version. Next to the DVD ReWritable (DVD+RW) standard a new recordable (R), i.e. write once, DVD+R standard was developed. The new DVD+R standard gets increasing attention as an important support for DVD+RW. A possible scenario is that the end customers have become so familiar with an optical write-once format that they might accept it more easily than a re-writable format.

An issue for both the R and RW formats is the limited capacity and therefore recording time because only single-stacked media are present. Note that for DVD-Video, which is a ROM disk, dual layer media already have a considerable market share. The dual layer DVD ROM format is called DVD-9 where 9 refers to the approximate data storage capacity in GB. A dual-layer, i.e. dual-stack, DVD+RW disk is probably feasible. However, it has become clear that a fully compatible disk, i.e. within the reflection and modulation specification of DVD-9, is very difficult to achieve and requires at least a major breakthrough for the properties of the amorphous/crystalline phase-change materials, which are used as recording layers in e.g. DVD+RW media. Without a full compatibility, the success of a dual-layer DVD+RW in the market is questionable.

In order to obtain a dual-layer DVD+R medium which is compatible with the dual-layer DVD-ROM standard, the effective reflectivity of both the upper L₁ layer and the lower L₀ layer should be at least 18%. Effective means that the reflection is measured as the portion of effective light coming back from the medium when both stacks L₀ and L₁ are present and focusing on L₀ and L₁ respectively. This implies that the L₀ stack as such requires a far higher reflection level of e.g. more than 50%, preferably more than 60%, because the L₁ stack absorbs a substantial portion of the incoming and outgoing light. It should be noted that in this document the convention of notation of L₀ and L₁, in which notation L₀ is the “closest” stack, i.e. closest to the radiation beam entrance face, has been changed: L₀ now is the deepest stack and L₁ is the stack closer to the radiation beam entrance face. In EP1067535A2 a translucent film is described corresponding to the second reflective layer of the medium of the opening paragraph. The translucent film is formed of a dielectric thin film such as SiC or Au. It is a disadvantage that a translucent film of SiC or Au that it has a relatively low reflection value or is relatively expensive to apply.

In order to obtain a dual-layer DVD+R medium which is compatible with the dual-layer DVD-ROM standard, the effective reflectivity of a light beam focused onto the data track of the L₀ or L₁ stack should be more than 18%. Use of Ag has the disadvantage that it is difficult to get the transmission above 50%, which is a practical requirement in order to achieve a reflection of the L₀ stack of more than 18%. Only in case of impractically thin dye layers, the transmission of the L₁ stack with a second reflective layer of Ag is higher than 50%. A thin dye layer is likely to deteriorate the recording characteristics. The use of even thinner Ag layers to achieve higher transmission is not recommended because of problems with homogeneity, surface roughness, reproducability, etcetera.

It is an object of the invention to provide an optical data storage medium of the type mentioned in the opening paragraph which during read out of written data is compatible with the DVD-9 ROM standard as far as reflection levels are concerned.

This object has been achieved in accordance with the invention by an optical storage medium, which is characterized in that the second reflective layer mainly comprises the metal Cu and has a thickness t_{MLn} selected from the range of 8-20 nm and the thickness t_{RL1} and k_{λ} of the recordable L₁ recording layer fulfils the formula t_{RL1}*k_{λ}≦8 nm. It was found that when using Cu in this thickness range an optimal balance between reflection and transmission is achieved. Compared to other metals, Cu shows superior transmission values in said thickness range. An additional advantage of Cu is that is has a high thermal conductivity and is relatively cheap. A high thermal conductivity is advantageous for the cooling behavior of the adjacent recording layer. Good cooling becomes more and more important at linear high recording velocities, e.g. 20 m/s or more. The product t_{RL1}*k_{λ} shall not exceed 8 nm in which case the requirement of an optical transmission level cannot be fulfilled anymore due to too high absorption of the radiation beam in the L₁ recording layer.

In an embodiment the recordable type L₁ recording layer comprises an organic dye. Organic dyes are frequently used as write-once recording layers and can be selected to have a relatively favorable optical transmission at the radiation beam wavelength.

In another embodiment t_{RL1} is selected from the range of 70-125 nm. This range is especially favorable in order to achieve a reflection value of more than 18% of the second L₁ recording stack.

In an embodiment a first auxiliary layer, transparent for the radiation beam and with a thickness smaller than 15 nm, is present sandwiched between the second reflective layer and the spacer layer. The first auxiliary layer serves as a barrier layer in order to prevent a chemical reaction between the L₁ recording layer and the spacer layer.

In another embodiment a second auxiliary layer, transparent for the radiation beam and with a thickness smaller than 15 nin, is present sandwiched between the second reflective layer and the L₁ recording layer. The second auxiliary layer serves as a barrier layer in order to prevent a chemical reaction between the L₁ recording layer and the second reflective layer. The auxiliary layer may comprise a material selected from the group of oxides and nitrides of silicon. Other transparent materials may be applied.

The invention will be elucidated in greater detail with reference to the accompanying drawings, in which

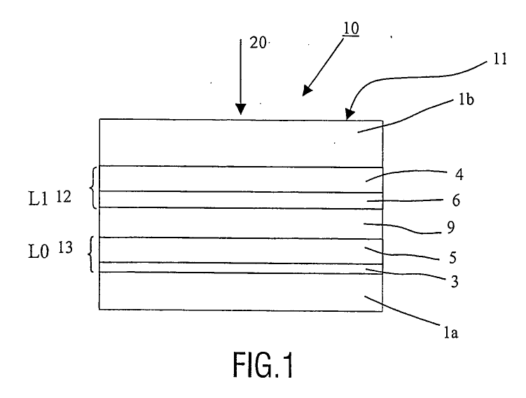

FIG. 1 schematically shows a cross-section of an embodiment of a multi-stack optical data storage medium according to the invention,

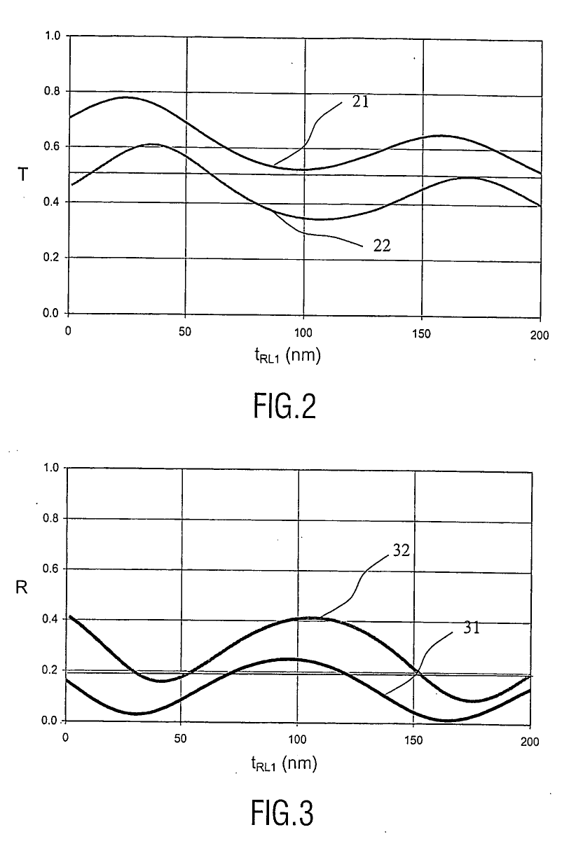

FIG. 2 shows the transmission as a function of the thickness of the L₁ recording stack, which comprises an organic dye, for the above medium when using Cu according to the invention or Ag,

FIG. 3 shows the reflection as a function of the thickness of the L₁ recording stack, which comprises an organic dye, for the above medium when using Cu according to the invention or Ag,

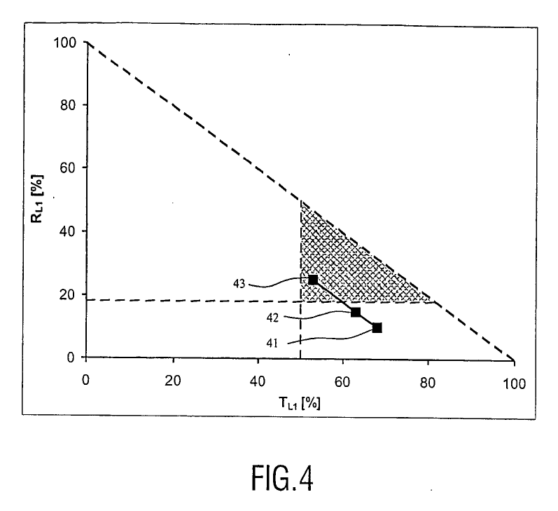

FIG. 4 shows measurements of reflection and transmission values of the L1 stack comprising Cu layers with different thicknesses.

In FIG. 1 a multi-stack optical data storage medium 10 for recording using a focused radiation beam is shown 20. The radiation beam 20 enters through an entrance face 11 of the medium 10 during recording and has a wavelength of 655 nm. The medium 10 comprises a first substrate 1a with present on a side thereof a first recording stack 13 named L₀, comprising a recordable type L₀ recording layer 5 of an organic dye and a first reflective layer 3 made of e.g. Al having a thickness of 100 nm present between the L₀ recording layer 5 and the first substrate 1a. A second substrate 1b has present on a side thereof a second recording stack 12 named L₁ comprising a recordable type L₁ recording layer 4, comprising an organic dye having a thickness t_{RL1} and a complex refractive index 2.44-0.06 i at the wavelength 655 nm and a second reflective layer 6 present adjacent the L₁ recording layer 4 at a side most remote from the entrance face 11. The second recording stack L₁ 12 is present at a position closer to the entrance face 11 than the L₀ recording stack 13. A radiation beam transparent spacer layer 9 is sandwiched between the recording stacks 12 and 13. The transparent spacer layer 9 has a thickness of 50 μm which is substantially larger than the depth of focus of the focused radiation beam 20. The second reflective layer 6 mainly comprises the metal Cu and has a thickness t_{ML1} of 20 nm and the thickness t_{RL1} of the recordable L₁ recording layer 4 is 80 nm. The value of t_{RL1}*k_{λ=655} nm is 1.6 nm. The surface of the substrate on the side of the recording stacks is, preferably, provided with a servotrack, which can be scanned optically. This servotrack is often constituted by a spiral-shaped groove and is formed in the substrate by means of a mould during injection molding or pressing. These grooves can be alternatively formed in a replication process in the synthetic resin of the spacer layer, for example, a UV light-curable acrylate. The thickness of the dye recording layer may vary between the portions in the groove and the portions adjacent the groove, i.e. on land. This is due to leveling out of the dye layer during its application on the surface containing grooves. In this case a good approximation value for t_{RL1} may be the average thickness. It should be noted that the second substrate 1b also may be a relatively thin, e.g. 100 μm, cover layer. A first auxiliary layer, transparent for the radiation beam and made of (ZnS)₈₀(SiO₂)₂₀, with a thickness of 10 nm is present sandwiched between the second reflective layer 6 and the spacer layer 9. The measured optical reflection and transmission values of the L₁ stack are 25% and 53% respectively (see FIG. 4).

In FIG. 2 the calculated optical transmission as a function of the thickness t_{RL1} of the recordable type L₁ recording layer 4, comprising an organic dye having a complex refractive index 2.44-0.06 i is shown when the second reflective layer 6 with a thickness of 10 nm is either Cu, represented by curve 21, or Ag, represented by curve 22. Note that Ag does not fulfil the requirement of a transmission level of larger than 50% in a usable thickness range of the dye L₁ recording layer 4. The radiation beam wavelength is 655 nm and the complex refractive index for Cu is n=0.227-3.665 i and for Ag is n=0.16-5.34 i. Only in case of impractically thin dye layers, the transmission with the thin Ag layer gets above 50%. A thin dye layer is likely to deteriorate the recording characteristics. The use of even thinner Ag layers to achieve higher transmission is not recommended because of problems with homogeneity, surface roughness, reproducibility, etc. Note that a k-value of 0.06 is relatively high and that the dyes used usually have a k-value of around 0.02 at the radiation beam wavelength.

In FIG. 3 the calculated optical reflection as a function of the thickness t_{RL1} of the recordable type L₁ recording layer 4, comprising an organic dye having a complex refractive index 2.44-0.06 i (λ=655 nm) is shown when the second reflective layer 6 with a thickness of 10 nm is either Cu, represented by curve 31, or Ag, represented by curve 32. Note that the usable thickness range of the L₁ recording layer when using Cu as second reflective layer lies between 70 and 125 nm. Ag has a wider range with a reflection level above 18% but is not usable because of the not achieved transmission requirement (see FIG. 2). Note that a k-value of 0.06 is relatively high and that the dyes used usually have a k-value of around 0.02 at the radiation beam wavelength.

In FIG. 4 measurements are shown of reflection and transmission values, at λ=655 nm, of the L₁ stack comprising, in this order, the following layers:
a 580 μm polycarbonate substrate 1b, through which the radiation beam enters,
a 80 nm organic dye layer with a refractive index 2.44-0.02 i,
a Cu layer having a thickness of 10, 15 or 20 nm denoted by reference numerals 41, 42 or 43 respectively,
a 10 nm capping layer of the material (ZnS)₈₀(SiO₂)₂₀,

a spacer layer 9 made of a sheet of polycarbonate bonded to the capping layer by means of a pressure sensitive adhesive (PSA). The capping layer prevents chemical interaction of the PSA material with the Cu layer. The optical reflection and transmission values of the L₁ stack at different Cu layer thicknesses for the above mentioned stack are represented in the following table:

| Cu layer thickness | | |
|---|---|---|
| (nm) | R_{L1} (%) | T_{L1} (%) |
| 10 | 10 | 68 |
| 15 | 15 | 63 |
| 20 | 25 | 53 |

Note that the values in the table are not in accordance with the calculated curves of FIG. 2 and FIG. 3, which assume a different k-value.

It should be noted that the above-mentioned embodiment illustrates rather than limits the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The mere fact that certain measures are recited in mutually different dependent claims does not indicate that a combination of these measures cannot be used to advantage.

According to the invention a multi-stack optical data storage medium is provided. The medium comprises a first substrate with present on a side thereof a first recording stack named L₀, a second substrate with present on a side thereof a second recording stack named L₁ comprising a recordable type L₁ recording layer having a thickness t_{RL1} and a complex refractive index n_{λ}−i*k_{λ} at a wavelength λ, a second reflective layer present adjacent the L₁ recording layer at a side most remote from a radiation beam entrance face of the medium, and said second recording stack L₁ being present at a position closer to the entrance face than the L₀ recording stack. A radiation beam transparent spacer layer is sandwiched between the recording stacks. In order to achieve compatibility with the DVD-9 ROM standard as far as reflection levels are concerned, the second reflective layer mainly comprises the metal Cu and has a thickness t_{MLn} selected from the range of 8-20 nm and the thickness t_{RL1} and k_{λ} of the recordable L₁ recording layer fulfils the formula t_{RL1}*k_{λ}≦8 nm.

1. A multi-stack optical data storage medium for recording using a focused radiation beam having a wavelength λ and entering through an entrance face of the medium during recording, comprising at least:
a first substrate with present on a side thereof:
a first recording stack named L₀, comprising a recordable type L₀ recording layer, and a first reflective layer present between the L₀ recording layer and the first substrate,
a second substrate with present on a side thereof:
a second recording stack named L₁ comprising a recordable type L₁ recording layer having a thickness t_{RL1} and a complex refractive index n_{λ}−i*k_{λ} at the wavelength λ, a second reflective layer present adjacent the L₁ recording layer at a side most remote from the entrance face, and said second recording stack L₁ being present at a position closer to the entrance face than the L₀ recording stack,
a spacer layer, transparent for the radiation beam, sandwiched between the recording stacks, said transparent spacer layer having a thickness substantially larger than the depth of focus of the focused radiation beam,
characterized in that the second reflective layer mainly comprises the metal Cu and has a thickness t_{MLn} selected from the range of 8-20 nm and the thickness t_{RL1} and k_{λ} of the recordable L₁ recording layer fulfils the formula t_{RL1}*k_{λ}≦8 nm.

2. A multi-stack optical data storage medium according to claim 1, wherein the recordable type L₁ recording layer comprises an organic dye.

3. A multi-stack optical data storage medium according to claim 2, wherein t_{RL1} is selected from the range of 70-125 nm.

4. A multi-stack optical data storage medium according to claim 2, wherein a first auxiliary layer, transparent for the radiation beam and with a thickness smaller than 15 nm, is present sandwiched between the second reflective layer and the spacer layer.

5. A multi-stack optical data storage medium according to claim 2, wherein a second auxiliary layer, transparent for the radiation beam and with a thickness smaller than 15 nm, is present sandwiched between the second reflective layer and the L₁ recording layer.

6. A multi-stack optical data storage medium according to claim 4, wherein the auxiliary layer comprises a material selected from the group of oxides and nitrides of silicon.

7. Use of an optical data storage medium as claimed in claim 1 for multi stack recording wherein the second recording stack L₁ has a reflectivity level of more than 18% and a transmission level of more than 50%.
